(19) United States
(12) Patent Application Publication
(10) Pub. No.: US 2021/0304131 A1
(43) Pub. Date: Sep. 30, 2021

(54) MANAGEMENT DEVICE, TRANSPORT SYSTEM, MANAGEMENT METHOD, AND PROGRAM

(71) Applicant: HONDA MOTOR CO., LTD., Tokyo (JP)

(72) Inventors: Kensaku Yamamoto, Wako-shi (JP); Yurie Kondo, Tokyo (JP); Yusuke Kawada, Wako-shi (JP); Koichi Ogura, Tokyo (JP); Ryohei Iwaki, Wako-shi (JP)

(21) Appl. No.: 17/191,751

(22) Filed: Mar. 4, 2021

(30) Foreign Application Priority Data
Mar. 31, 2020 (JP) 2020-063758

(51) Int. Cl. G06Q 10/08; B60W 60/00

(52) U.S. Cl. CPC G06Q 10/0833; B60W 60/00256; G06Q 10/0835; G06Q 10/0832

(57) ABSTRACT

A management device, a transport system, a management method, and a program capable of improving convenience are provided. The management device is a management device that is configured to manage a service using an unmanned delivery unit including a package storage space. The management device includes: an acquisition part configured to acquire a detection result, which is acquired by the weight detection part, relating to a first package loaded into the unmanned delivery unit by a user from the unmanned delivery unit; a financial accounting part configured to settle a delivery fee of the first package on the basis of the detection result, which is acquired by the weight detection part, relating to the first package that is acquired by the acquisition part; and a guide part configured to cause a terminal device to output information for guiding the delivery fee of the first package that is settled by the financial accounting part.

### CROSS-REFERENCE TO RELATED APPLICATION

Priority is claimed on Japanese Patent Application No. 2020-063758, filed Mar. 31, 2020, the content of which is incorporated herein by reference.

### BACKGROUND OF THE INVENTION

### Field of the Invention

The present invention relates to a management device, a transport system, a management method, and a program.

### Description of Related Art

Unmanned delivery systems that deliver packages using autonomous mobile devices are known (Patent Document 1 (Japanese Unexamined Patent Application, First Publication No. 2018-058656)).

### SUMMARY OF THE INVENTION

In the related art described above, there are cases in which convenience relating to payment of fees is not sufficient.

The present invention is realized in view of such situations, and one object thereof is to provide a management device, a transport system, a management method, and a program capable of improving convenience.

A management device, a transport system, a management method, and a program according to the present invention have the following configuration.

(1) A management device according to an aspect of the present invention is a management device that is configured to manage a service using an unmanned delivery unit having a weight detection part, the management device including: an acquisition part configured to acquire a detection result, which is acquired by the weight detection part, relating to a first package loaded into the unmanned delivery unit by a user from the unmanned delivery unit; a financial accounting part configured to settle a delivery fee of the first package on the basis of the detection result, which is acquired by the weight detection part, relating to the first package that is acquired by the acquisition part; and a guide part configured to cause a terminal device to output information for guiding the delivery fee of the first package that is settled by the financial accounting part.

(2) In the management device according to the aspect (1), the guide part may cause the terminal device to output information for guiding an estimate of the delivery fee of the first package before the first package is loaded into the unmanned delivery unit.

(3) In the management device according to the aspect (2), a reception part configured to receive a delivery request including items and quantities of contents of the first package from the terminal device may be further included, and the guide part may cause the terminal device to output information for guiding an estimate of the delivery fee of the first package on the basis of the items and the quantities of the contents of the first package included in the delivery request received by the reception part.

(4) In the management device according to the aspect (2), a reception part configured to receive a report of the weight of the first package from the terminal device may be further included, and the guide part may cause the terminal device to output information for guiding an estimate of the delivery fee of the first package on the basis of the report of the weight of the first package received by the reception part.

(5) In the management device according to any one of the aspects (1) to (4), the unmanned delivery unit may include a plurality of package storage spaces, and the guide part may cause the terminal device to output information representing a package storage space to receive the first package selected from among the plurality of package storage spaces on the basis of the weight balance between the weight of the first package on the basis of the detection result acquired by the weight detection part and the weight of a second package stored in the unmanned delivery unit in advance or later.

(6) In the management device according to any one of the aspects (1) to (5), the unmanned delivery unit may include a first package storage space and a second package storage space disposed below the first package storage space, and the guide part may cause the terminal device to output information representing the second package storage space as a package storage space to receive the first package in a case in which the weight of the first package on the basis of the detection result acquired by the weight detection part satisfies a first predetermined condition.

(7) In the management device according to any one of the aspects (1) to (6), a reception part configured to receive a delivery request including items of the first package from the terminal device and a transport condition judgement part configured to judge whether or not the weight of the first package satisfies a second predetermined condition relating to an item or the weight on the basis of the items of the contents of the first package included in the delivery request received by the reception part before the unmanned delivery unit suited for collection of the first package is selected may be further included.

(8) In the management device according to the aspect (7), a selection part configured to select the unmanned delivery unit of which a vacancy status of the package storage space satisfies a third predetermined condition as the unmanned delivery unit suited for collection of the first package in a case in which it is judged by the transport condition judgement part that the weight of the first package satisfies the second predetermined condition may be further included.

(9) In the management device according to any one of the aspects (1) to (8), the guide part may cause the terminal device to output information for guiding items of contents of packages that can be delivered by the unmanned delivery unit.

(10) A transport system according to one aspect of the present invention is a transport system including: the management device according to any one of the aspects (1) to (9); and an unmanned delivery unit, in which the unmanned delivery unit has a measurement area in an upper face of a vehicle body of the unmanned delivery unit, and the weight detection part is configured to detect the weight of a package loaded into the measurement area.

(11) A transport system according to an aspect of the present invention is a transport system including: the management device according to any one of the aspects (1) to (9); and an unmanned delivery unit, in which the weight detection part is configured to detect the weight of a package loaded into the unmanned delivery unit on the basis of a change in the entire weight of the unmanned delivery unit.

(12) A management method according to an aspect of the present invention is a management method using a management device that is configured to manage a service using an unmanned delivery unit including a weight detection part, the management method including: acquiring a detection result, which is acquired by the weight detection part, relating to a first package loaded into the unmanned delivery unit by a user from the unmanned delivery unit; settling a delivery fee of the first package on the basis of the acquired detection result, which is acquired by the weight detection part, relating to the first package; and outputting information for guiding the settled delivery fee of the first package to a terminal device.

(13) A program according to an aspect of the present invention is a program causing a computer of a management device that is configured to manage a service using an unmanned delivery unit including a weight detection part to perform: acquiring a detection result, which is acquired by the weight detection part, relating to a first package loaded into the unmanned delivery unit by a user from the unmanned delivery unit; settling a delivery fee of the first package on the basis of the acquired detection result, which is acquired by the weight detection part, relating to the first package; and causing a terminal device to output information for guiding the settled delivery fee of the first package.

According to aspects (1) to (13), the convenience can be improved.

### BRIEF DESCRIPTION OF THE DRAWINGS

FIG. 1 is a configuration diagram of a transport system 1 according to a first embodiment.

FIG. 2 is a perspective view of a package carrier 200.

FIG. 3 is a diagram showing an outer appearance of the package carrier 200.

FIG. 4 is a diagram showing the functional configuration of the package carrier 200.

FIG. 5 is a configuration diagram of a management device 300.

FIG. 6 is a diagram showing an example of details of user information 392.

FIG. 7 is a diagram showing an example of a transport service application screen for inputting application information that is displayed in a display unit of a terminal device 100.

FIG. 8 is a diagram showing another example of the transport service application screen displayed in the display unit of the terminal device 100.

FIG. 9 is a diagram showing an example of details of an application information list 394.

FIG. 10 is a diagram conceptually showing details of transfer schedule information 396.

FIG. 11 is a diagram showing an example of details of average weight information 395a.

FIG. 12 is a diagram showing an example of details of weight fee information 395b.

FIG. 13 is a diagram showing another example of the transport service application screen displayed in the display unit of the terminal device 100.

FIG. 14 is a sequence diagram showing an example of the flow of a process for pickup that is executed in the transport system 1.

FIG. 15 is a diagram showing an example of a transport service application screen for inputting application information that is displayed in a display unit of a terminal device 100 according to a second embodiment.

### DETAILED DESCRIPTION OF THE INVENTION

Hereinafter, a management device, a transport system, a management method, and a program according to embodiments of the present invention will be described with reference to the drawings. A transport system includes at least a management device and an unmanned delivery unit. For example, the unmanned delivery unit can autonomously travel on a road without having a driver getting thereon and includes a package storage space that is open or closed by an opening/closing door.

The unmanned delivery unit recognizes a status of the outside using a monitoring unit such as a camera, a radar device, or a Light Detection and Ranging (LIDAR). The unmanned delivery unit moves on a road to avoid an on-road obstacle while traveling along a path directed by the management device as a basic principle. The unmanned delivery unit has vehicle wheels, for example, driven by a motor and moves on a road at a speed of about 10 [km]. The package storage space of the unmanned delivery unit, for example, forms spaces for loading a plurality of packages that are partitioned from each other, and a plurality of users can load (cause to be carried) respective packages therein.

The management device manages (controls) the operation of the unmanned delivery unit. The management device may be a device that is placed at a place different from that of the unmanned delivery unit and may communicate with the unmanned delivery unit through a network. Some or all of the functions of the management device may be mounted in the unmanned delivery unit. The management device, for example, generates transport schedule information (transfer schedule information) on the basis of application information that is acquired from a user's terminal device through communication. The management device instructs the unmanned delivery unit of a path and a stop place of the unmanned delivery unit, an open/closed state of the door of the package storage space, and the like on the basis of the transport schedule information.

In the following description, the management device is a device that is placed at a place different from that of the unmanned delivery unit (for example, a device in a form called a cloud server). The management device communicates with a user's terminal device and the unmanned delivery unit through a network, thereby realizing the functions described above.

### First Embodiment

### [1. Entire Configuration]

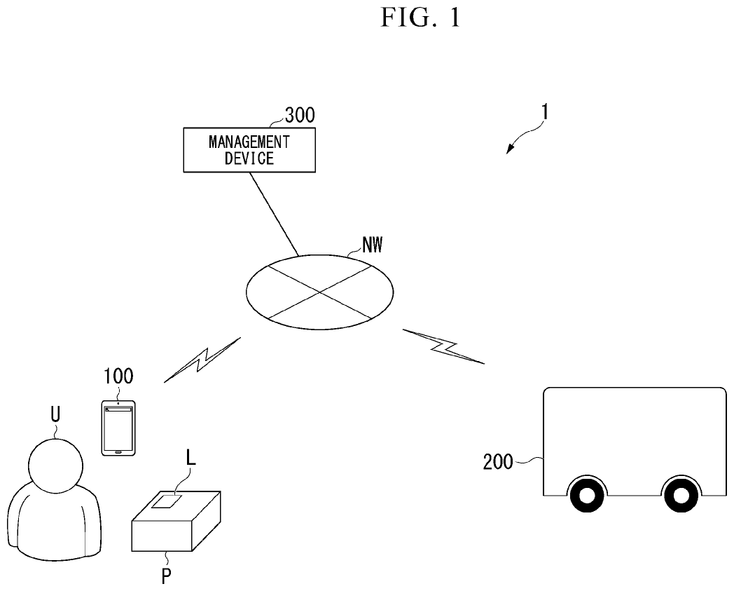

FIG. 1 is a configuration diagram of a transport system 1 that includes a package carrier (unmanned delivery vehicle) 200, which is an example of an unmanned delivery unit, and a management device 300. The transport system 1 includes one or more package carriers 200 and the management device 300. The management device 300 communicates with a terminal device 100 used by a user U through a network NW. The network NW includes the Internet, a Wide Area Network (WAN), a Local Area Network (LAN), a public communication circuit, a provider device, a dedicated line, a radio base station, and the like. The management device 300 communicates with the package carrier 200 through the network NW. “A terminal device used by a user” may be a terminal device that can be used by many unspecified persons such as terminal devices of a network café and may include a terminal device that is temporarily used by the user. In any case, “a terminal device of a user” may be a terminal device of which an operating user is specified, for example, through a login operation of inputting a login name. Here, the “terminal device” is not limited to the examples described above and, as will be described below, an in-vehicle device mounted in the package carrier 200 may correspond to one example of the “terminal device”.

A user U transmits application information (a delivery request) for requesting for transporting a package P using the terminal device 100 to the management device 300. A label L in which identification information of a package P and/or a user U is written or that is stored in a built-in IC tag or the like is assigned to the package P. Here, “being assigned”, for example, means being attached using a seal or the like.

For example, the terminal device 100 is a smartphone, a tablet terminal, a personal computer, or the like. In the terminal device 100, an application program for using the service described above, a browser, or the like is operated and supports services described below. In the following description, it is premised that the terminal device 100 is a smartphone, and an application program for receiving a service (a transport service application) is operated. The transport service application transmits application information from a user U to the management device 300 or provides information based on information received from the management device 300 by communicating with the management device 300 in accordance with a user's operation. The application information is electronic information for requesting transporting a package P over a designated section using the package carrier 200.

### [2. Package Carrier]

### [2.1 Overview of Package Carrier]

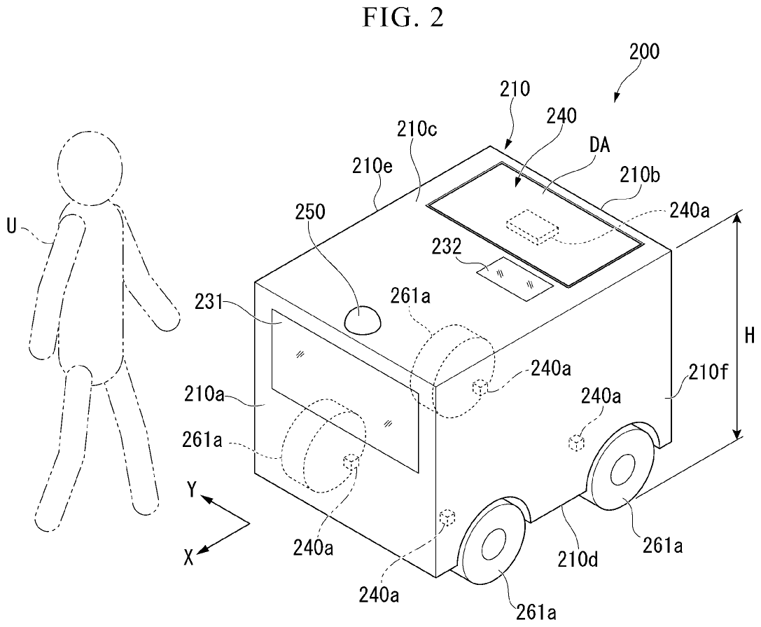

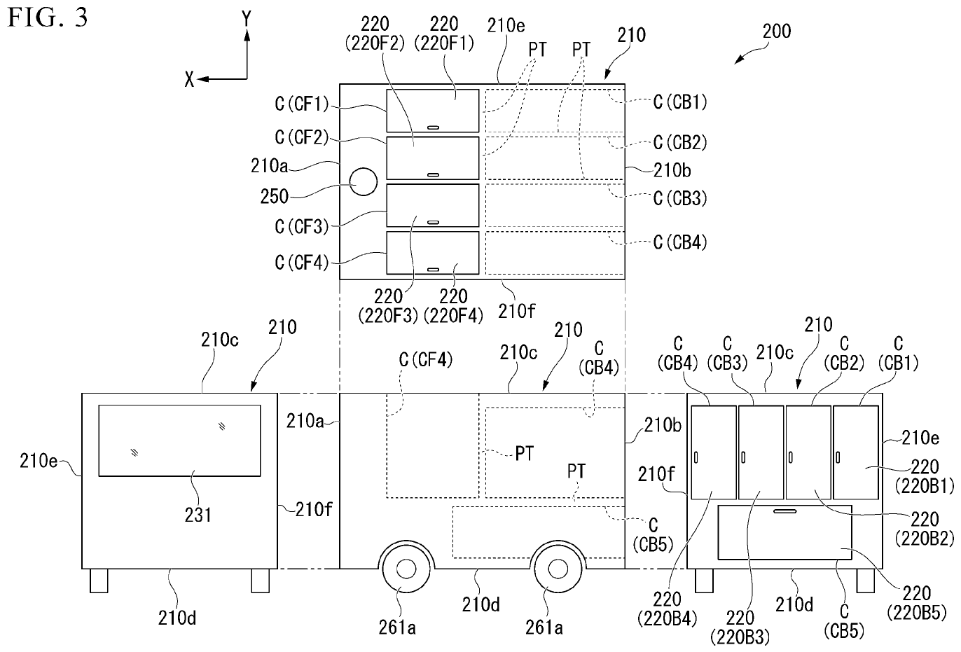

FIG. 2 is a perspective view of the package carrier 200. The package carrier 200 is, for example, a relatively small (small height) vehicle and has a height that is smaller than an average height of the user U. For example, a height H of the package carrier 200 is equal to or smaller than 120 cm. For example, the package carrier 200 includes a vehicle body 210, a plurality of doors 220 (see FIG. 3), first and second display devices 231 and 232, a weight detection part 240, and a monitoring unit 250.

The vehicle body 210 is, for example, formed in a box shape and includes a front face 210a, a rear face 210b, an upper face 210c, a lower face 210d, a left face 210e, and a right face 210f. The vehicle body 210 is not limited to a rectangular parallelepiped shape and may include inclining portions or portions formed in a curved shape. Inside the vehicle body 210, a plurality of package storage spaces C (see FIG. 3) in which packages P can be respectively stored are provided. The package storage spaces C and the doors 220 will be described below in detail.

A first display device 231 is disposed on the front face 210a of the vehicle body 210. For example, the first display device 231 is a liquid crystal display or an organic electroluminescence (organic EL) display. The first display device 231 is a display unit that displays various kinds of information including a delivery status. During the movement of the package carrier 200 (including a time at which the vehicle stops during the movement), the first display device 231 displays information for notifying nearby traffic participants (vehicles and/or pedestrians) of a status of the package carrier 200 such as “package delivery in progress”, “traveling in progress”, “stopping”, or the like.

For example, a second display device 232 is disposed on the upper face 210c of the vehicle body 210. Here, the second display device 232 may be disposed on any one of the front face 210a, the rear face 210b, the left face 210e, and the right face 210f instead of the upper face 210c of the vehicle body 210. For example, the second display device 232 is a liquid crystal display or an organic electroluminescence (organic EL) display. A detection result acquired by the weight detection part 240 is displayed in the second display device 232. In addition, a delivery fee of a package P that is settled on the basis of the detection result acquired by the weight detection part 240 may be displayed in the second display device 232. This will be described below. In addition, the second display device 232 may be omitted. In such a case, details displayed in the second display device 232 may be displayed in the first display device 231. The second display device 232 (or a unit including the second display device 232 and a controller 270 to be described below) that is an in-vehicle device is another example of the “terminal device”.

In a case in which a package P is loaded into the vehicle body 210 by a user U, the weight detection part 240 can measure the weight of the package P. For example, the weight detection part 240 is disposed on the upper face 210c of the vehicle body 210 and can measure the weight of a package P loaded on the upper face 210c of the vehicle body 210 by a user U. For example, a weight detection area (measurement area) DA is disposed on the upper face 210c of the vehicle body 210. For example, the weight detection area DA is formed by a member separate from the other part of the upper face 210c of the vehicle body 210 such that it can vertically move with respect to the other part of the upper face 210c of the vehicle body 210 (it can lower in accordance with the weight of the package P). For example, the weight detection part 240 includes one or more weight sensors 240a disposed below the weight detection area DA. The weight detection part 240 detects the weight of a package P loaded on the weight detection area DA. The weight detection part 240 causes the second display device 232 to display the detected weight of the package P and transmits the detected weight to the management device 300.

Here, the configuration of the weight detection part 240 is not limited to the example described above. The weight detection part 240 may include weight sensors 240a, for example, in suspensions that support the vehicle wheel 261a of the vehicle body 210 without including a weight detection area DA that is particularly set. In such a case, the weight detection part 240 may detect the weight of a package P loaded on the upper face 210c of the vehicle body 210 on the basis of a difference between a value detected by the weight sensor 240a before loading of the package P at an arbitrary place in the vehicle body 210 and a value detected by the weight sensor 240a after loading of the package P at an arbitrary place in the vehicle body 210 (in other words, a change in the weight of the entire package carrier 200).

In this embodiment, “in a case in which a package is loaded into the vehicle body, the weight of the package can be measured (by the weight detection part)” is not limited to a case in which the package P is loaded on the upper face 210c of the vehicle body 210. For example, it also includes a case in which the weight of the package P is measured by loading the package P inside of the vehicle body 210 (for example, the package storage space C). For example, such a modified example can be realized by disposing the weight sensor 240a inside of the vehicle body 210 (for example, the package storage space C) or disposing the weight sensor 240a in a suspension, which supports the vehicle wheel 261a of the vehicle body 210, as described above or the like.

For example, the monitoring unit 250 is disposed on the upper face 210c of the vehicle body 210. The monitoring unit 250 includes a camera, a radar device, a light detection and ranging (LIDAR), and the like. Detection results acquired by the monitoring unit 250 are output to a controller 270 (to be described below).

### [2.2 Arrangement of Package Storage Space and Doors]

FIG. 3 is a diagram showing an outer appearance of the package carrier 200. In FIG. 3, for the convenience of description, illustration of the second display device 232 and the weight detection part 240 is omitted. In this embodiment, the plurality of package storage spaces C include upper-stage front part storage spaces CF1, CF2, CF3, and CF4, upper-stage rear part storage spaces CB1, CB2, CB3, and CB4, and a lower-stage rear part storage space CB5.

The upper-stage front part storage spaces CF1, CF2, CF3, and CF4 are aligned in a vehicle width direction Y. Each of the upper-stage front part storage spaces CF1, CF2, CF3, and CF4 has an internal space (a housing part) in which a package P can be stored and an opening that opens toward the upper side of the vehicle body 210. The upper-stage front part storage spaces CF1, CF2, CF3, and CF4 are partitioned by partitions PT. Each of the upper-stage front part storage spaces CF1, CF2, CF3, and CF4 is one example of “a first package storage space”.

The upper-stage rear part storage spaces CB1, CB2, CB3, and CB4 are disposed on the rear side of the upper-stage front part storage spaces CF1, CF2, CF3, and CF4. The upper-stage rear part storage spaces CB1, CB2, CB3, and CB4 are aligned in the vehicle width direction Y. Each of the upper-stage rear part storage spaces CB1, CB2, CB3, and CB4 has an internal space (a housing part) in which a package P can be stored and an opening that opens toward the rear side of the vehicle body 210. The upper-stage rear part storage spaces CB1, CB2, CB3, and CB4 are partitioned by the partitions PT. The upper-stage rear part storage spaces CB1, CB2, CB3, and CB4 are partitioned by the partitions PT that partition the upper-stage front part storage spaces CF1, CF2, CF3, and CF4. Each of the upper-stage rear part storage spaces CB1, CB2, CB3, and CB4 is another example of the “first package storage space”.

The lower-stage rear part storage space CB5 is disposed below the upper-stage rear part storage spaces CB1, CB2, CB3, and CB4. In other words, the upper-stage rear part storage spaces CB1, CB2, CB3, and CB4 and the lower-stage rear part storage space CB5 are vertically aligned. The lower-stage rear part storage space CB5 has an internal space (a housing part) in which a package P can be stored and an opening that opens toward the rear side of the vehicle body 210. The upper-stage rear part storage spaces CB1, CB2, CB3, and CB4 and the lower-stage rear part storage space CB5 are partitioned by the partitions PT.

An internal space of the lower-stage rear part storage space CB5 is larger than an internal space of each of the upper-stage front part storage spaces CF1, CF2, CF3, and CF4 and the upper-stage rear part storage spaces CB1, CB2, CB3, and CB4. The area of the opening of the lower-stage rear part storage space CB5 is larger than an area of the opening of each of the upper-stage front part storage spaces CF1, CF2, CF3, and CF4 and the upper-stage rear part storage spaces CB1, CB2, CB3, and CB4. The lower-stage rear part storage space CB5 is a storage space in which a relatively large package P or a relatively heavy package P is stored. The lower-stage rear part storage space CB5 is one example of “a second package storage space”.

For example, each of the upper-stage front part storage spaces CF1, CF2, CF3, and CF4, the upper-stage rear part storage spaces CB1, CB2, CB3, and CB4, and the lower-stage rear part storage space CB5 has an opening that is formed to be smaller than a depth of the internal space. For example, a vertical dimension and a horizontal dimension that define an opening (width) of each of the storage spaces described above is smaller than a depth of the internal space of each of the storage spaces. For this reason, for example, in a case in which it is detected that a package P has been put into one storage space by a sensor disposed in each storage space, the controller 270 of the package carrier 200 to be described below (or an accounts processing part 380 of the management device 300) determines that there is no problem in the size of the package P (the package P has dimensions equal to or smaller than prescribed dimensions).

In this embodiment, the plurality of doors 220 include upper doors 220F1, 220F2, 220F3, and 220F4, rear doors 220B1, 220B2, 220B3, and 220B4, and a rear door 220B5. For example, these doors 220 can be opened, for example, up to 90 degrees with respect to a closing position at which the opening of the package storage space C is closed due to being axially supported by a hinge not shown in the drawing.

The upper doors 220F1, 220F2, 220F3, and 220F4 are disposed in the upper face 210c of the vehicle body 210. The upper doors 220F1, 220F2, 220F3, and 220F4 are respectively disposed for openings of the upper-stage front part storage spaces CF1, CF2, CF3, and CF4 to have a one-to-one relation. The upper doors 220F1, 220F2, 220F3, and 220F4 respectively close the upper-stage front part storage spaces CF1, CF2, CF3, and CF4 from the side above to be openable.

The rear doors 220B1, 220B2, 220B3, and 220B4 are disposed in the rear face 210b of the vehicle body 210. The rear doors 220B1, 220B2, 220B3, and 220B4 are respectively disposed in openings of the upper-stage rear part storage spaces CB1, CB2, CB3, and CB4 to have a one-to-one relation. The rear doors 220B1, 220B2, 220B3, and 220B4 respectively close the upper-stage rear part storage spaces CB1, CB2, CB3, and CB4 from the rear side to be openable. The rear door 220B5 is disposed in the rear face 210b of the vehicle body 210. The rear door 220B5 is disposed in an opening of the lower-stage rear part storage space CB5 and closes the lower-stage rear part storage space CB5 from the rear side to be openable.

### [2.3 Functional Configuration of Package Carrier]

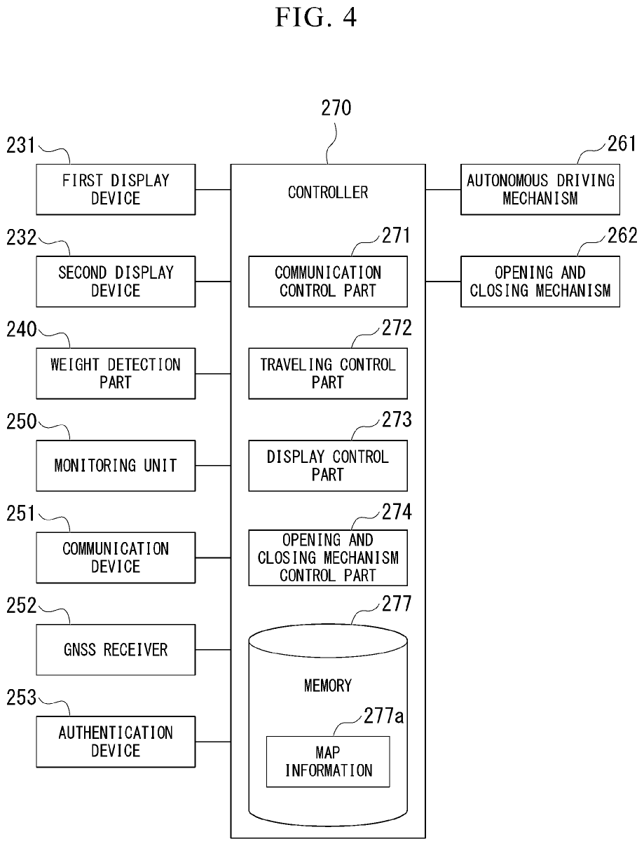

FIG. 4 is a diagram showing the functional configuration of the package carrier 200. For example, the package carrier 200 includes a communication device 251, a GNSS receiver 252, an authentication device 253, an autonomous driving mechanism 261, an opening and closing mechanism 262, and a controller (a control unit) 270 in addition to the first and second display device 231 and 232, the weight detection part 240, and the monitoring unit 250 described above.

For example, the communication device 251 is a radio communication module that is used for a connection to the network NW or a direct communication with another vehicle, a terminal device of a pedestrian, or the like. The communication device 251 performs radio communication on the basis of Wi-Fi, Dedicated Short Range Communications (DSRC), Bluetooth (a registered trademark), or any other communication standard. As the communication device 251, a plurality of communication devices according to uses may be provided.

The GNSS receiver 252 measures the position of its own device (the position of the package carriers 200) on the basis of radio waves arriving from GNSS satellites (for example, GPS satellites). The GNSS receiver 252 outputs a position measurement result to the controller 270.

The authentication device 253 is a device that is used for checking whether a user U conveying a package P into the package carrier 200 is an authenticated user (authenticating a user). An authenticated user represents a user who has an agreement (reservation) regarding transportation of a package with the management device 300. The authentication device 253 may be an arbitrary device such as a short-distance radio communication device, a biometric authentication device, a password input device, or the like as long as it has an authentication function. The authentication device 253 outputs an authentication result to the controller 270. For example, the authentication device 253 may be disposed integrally with the first display device 231 or the second display device 232.

The autonomous driving mechanism 261 includes a plurality of vehicle wheels 261a (see FIG. 2), a drive force source such as a motor, an energy storage unit such as a battery, a steering mechanism, and the like. The autonomous driving mechanism 261 causes the package carrier 200 to automatically travel in an arbitrary direction in accordance with an instruction from the controller 270 of the package carrier 200. The autonomous driving mechanism 261 is one example of “a drive device”.

The opening and closing mechanism 262 is disposed for each of the plurality of doors 220 and includes a motor, an arm, and the like. The opening and closing mechanism 262 individually opens or closes the door 220. For example, a switch detecting whether the door 220 has been manually closed is attached to the opening and closing mechanism 262.

The controller 270, for example, includes a communication control part 271, a traveling control part 272, a display control part 273, and an opening and closing mechanism control part 274. Such constituent elements, for example, are realized by a hardware processor such as a central processing unit (CPU) executing a program (software). Some or all of such constituent elements may be realized by hardware (a circuit unit; including circuitry) such as large scale integration (LSI), an application specific integrated circuit (ASIC), a field-programmable gate array (FPGA), or a graphics processing unit (GPU) or may be realized by software and hardware in cooperation. The program may be stored in a storage device (a storage device including a non-transitory storage medium) such as an HDD or a flash memory in advance or may be stored in a loadable/unloadable storage medium (a non-transitory storage medium) such as a DVD or a CD-ROM and installed in a storage device by loading the storage medium in a drive device. The controller 270 includes a memory 277 that stores the map information 277a. The memory 277 is an HDD, a flash memory, a ROM, or a random access memory (RAM).

The communication control part 271 acquires information of a path from the management device 300 through the communication device 251 and outputs the acquired information to the traveling control part 272. The communication control part 271 uploads position information, which represents a position measured by the GNSS receiver 252, to the management device 300 using the communication device 251. The upload of position information, for example, is periodically performed in units of milliseconds to seconds.

The traveling control part 272 performs control of the autonomous driving mechanism 261 such that the package carrier 200 travels along a path designated by the management device 300. For example, the traveling control part 272 matches a path acquired from the management device 300 with the map information 277a and the output of the monitoring unit 250 and determines a detailed path along which the package carrier 200 should travel. The traveling control part 272 causes the package carrier 200 to autonomously travel while avoiding a contact with objects (including a guard rail, a curbstone, and the like) of which positions and speeds have been input from the monitoring unit 250 while traveling along the path as a principle.

In a case in which a stop instruction is acquired from the management device 300, the traveling control part 272 causes the package carrier 200 to stop. Instead of this, in a case in which information of a stop position is included in the information of the path, the traveling control part 272 may cause the package carrier 200 to stop when a measurement result acquired by the GNSS receiver 252 and the stop position coincide with each other. In other words, a stop instruction or the information relating to a stop position is given from the management device 300 to the traveling control part 272, and the traveling control part 272 causes the package carrier 200 to stop in accordance with this. Positions at which the package carrier 200 is caused to stop include a position on a road. Particularly, in a view in which a user U conveys a package P into the package storage space C of the package carrier 200, the package carrier 200 stops on a road, a parking lot, or the like.

The display control part 273 controls videos (or images) that are displayed in the first and second display devices 231 and 232. The opening and closing mechanism control part 274 drives the opening and closing mechanism 262 at a timing instructed from the management device 300. In accordance with this, the opening and closing mechanism control part 274 automatically opens the door 220, and the package storage space C is open to the outside of the vehicle body 210.

### [3. Management Device]

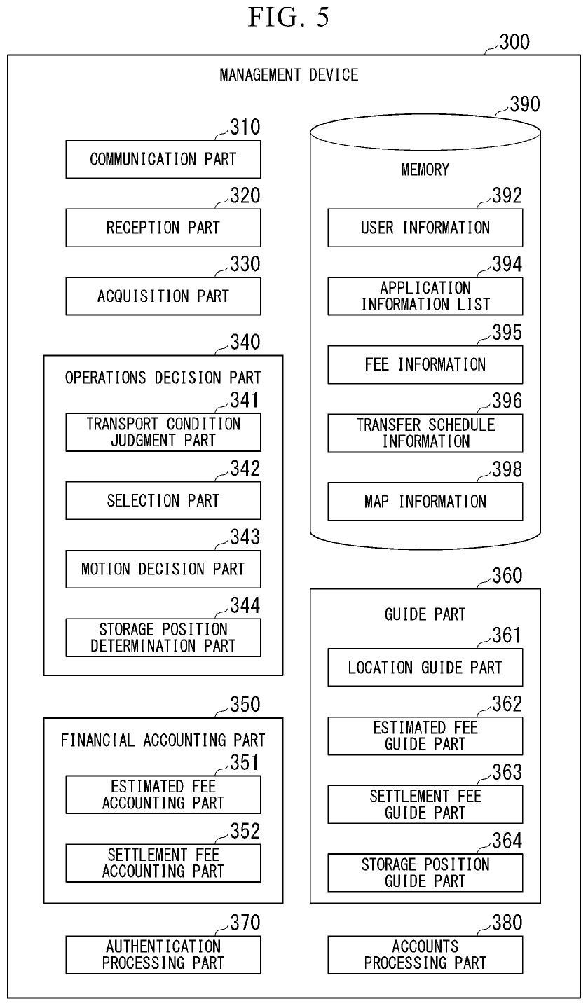

FIG. 5 is a configuration diagram of the management device 300. For example, the management device 300 includes a communication part 310, a reception part 320, an acquisition part 330, an operations decision part 340, financial accounting part 350, a guide part 360, an authentication processing part 370, and an accounts processing part 380. Such constituent elements, for example, are realized by a hardware processor such as a CPU executing a program (software). Some or all of such constituent elements may be realized by hardware (a circuit unit; including circuitry) such as LSI, an ASIC, an FPGA, or a GPU or may be realized by software and hardware in cooperation. The program may be stored in a storage device (a storage device including a non-transitory storage medium) such as an HDD or a flash memory in advance or may be stored in a loadable/unloadable storage medium (a non-transitory storage medium) such as a DVD or a CD-ROM and installed in a storage device by loading the storage medium in a drive device. The management device 300 may include a memory 390. The memory 390 is realized by a DVD, a random access memory (RAM), a flash memory, or the like. In the memory 390, information of user information 392, an application information list 394, fee information 395, a transfer schedule information 396, map information 398, and the like is stored.

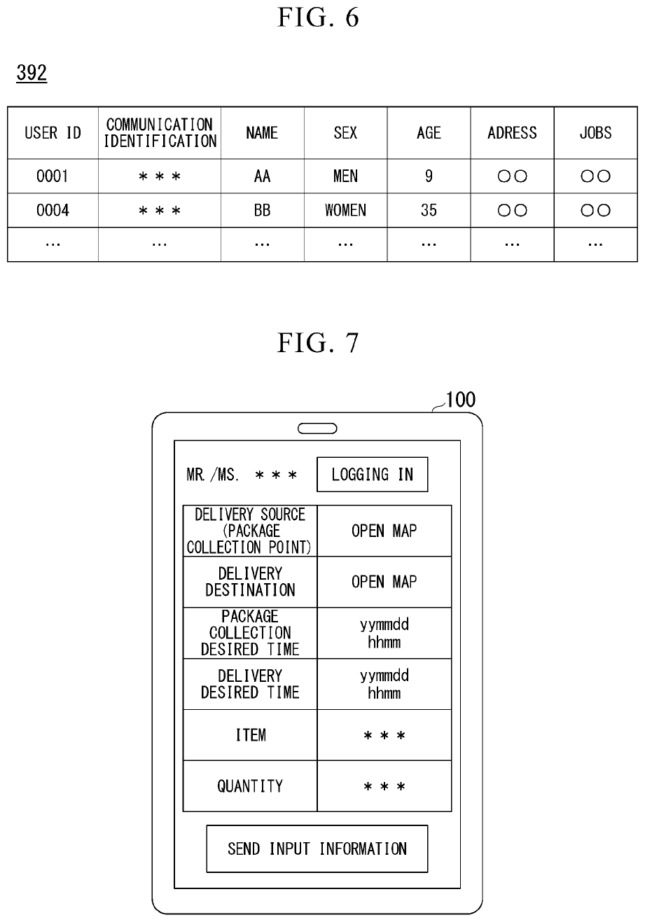

FIG. 6 is a diagram showing an example of details of the user information 392. For example, the user information 392 is information in which information of communication identification information, a name, a sex, an age, an address, a job, and the like is associated with a user ID that is identification information of a user. Each item of the user information 392 is registered in advance at the time of subscription to a service managed by the management device 300 or the like. The communication identification information is information that is necessary for transmitting information to the terminal device 100. The communication identification information, for example, is information of an application ID assigned to an application program, an Internet Protocol (IP) address, a media access control (MAC) address, a mail address, and the like.

The communication part 310, for example, is a network card that is used for a connection to the network NW. The communication part 310 communicates with the terminal device 100 and the package carrier 200 through the network NW.

The reception part 320 acquires (receives) application information transmitted from the terminal device 100 of the user through the communication part 310 and adds the acquired application information to the application information list 394. FIG. 7 is a diagram showing an example of a transport service application screen for inputting application information that is displayed in the display unit of a terminal device 100. As shown in the drawing, on the transport service application screen, a delivery source place (a package loading place and a package collection place), a delivery destination place (a package unloading place), a package collection desired time, a delivery desired time, items and quantities of contents of the package, and the like can be input. On the transport service application screen, information input by the user U is transmitted to the management device 300 as application information (delivery request). For example, a delivery source place and a delivery destination place are input when the terminal device 100 displays a map, and the user U designates the places on the map.

Here, “an item of a package” or “an item of contents of a package” is information that represents a kind of the contents of the package P. “An item of a package” or “an item of contents of a package” is, for example, “clothing”, “fabric product”, “towel”, “shoes”, “pouch”, “bag”, “baby's ware”, “glasses”, “stationary”, “detergent”, “cooking tool”, “bathing agent”, “book”, “CD/DVD”, “accessary”, “clock”, “battery”, and the like. On the transport service application screen, in order to urge a user U to input an item of contents of a package P, for example, a list of items may be displayed as multiple choices (for example, displayed in a pull-down menu or the like). Two or more “items” may be selected for one package P. Here, “quantity” represents the quantity of contents for each item included in one package P. For example, in a case in which three books are included in one package P, “book” is input as an “item”, and “three” is input as “quantity”. For example, on the transport service application screen displayed in the display unit of the terminal device 100, a list of items of contents of packages P that can be delivered by the package carrier 200 is displayed, whereby kinds of package P that can be delivered by the package carrier 200 are guided to the user U.

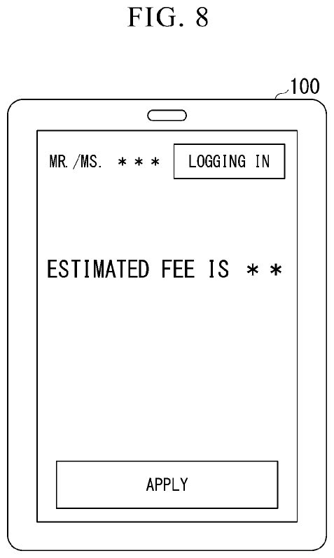

FIG. 8 is a diagram showing another example of the transport service application screen displayed in the display unit of the terminal device 100. In this embodiment, when the application information shown in FIG. 7 is input, an estimate of a delivery fee (the amount of the estimate) of a package P is calculated by the financial accounting part 350 of the management device 300 on the basis of the input application information. The calculated estimate of the delivery fee is displayed in the terminal device 100 using the transport service application screen. In the case of agreeing with the displayed estimate, the user U taps a button that corresponds to “Apply” displayed on the transport service application screen. In accordance with this, an application for delivery of the package P is completed.

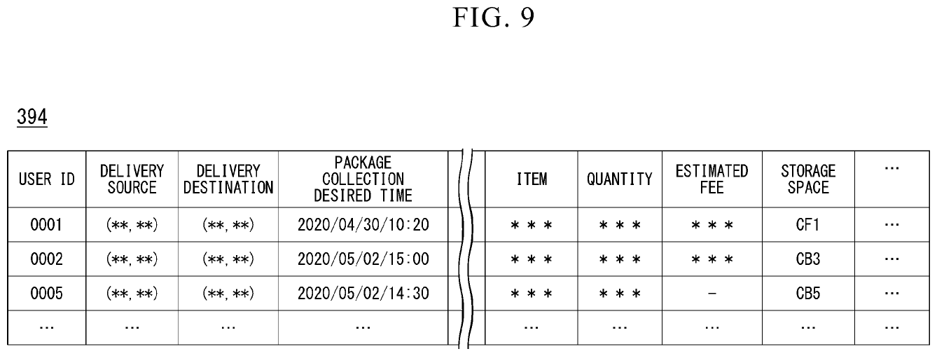

FIG. 9 is a diagram showing an example of details of the application information list 394. For example, the application information list 394 is information in which a user ID of a user who has transmitted application information, a delivery source place that becomes a start point of a section relating to transport of a package and a delivery destination place that becomes an end point of the section, a package collection desired date and time, a delivery desired date and time, a package item, the quantity of contents, an estimate of a delivery fee (the amount of estimate), a storage space, and the like are associated with each other. The “storage space” will be described below. One set of a user ID, a delivery source place, a delivery destination place, a delivery desired date and time, items and quantities of contents of a package, an estimate of a delivery fee (the amount of the estimate), and a package storage space C in which the package is stored, which relates to one piece of application information will be referred to as a record. The application information is information in an arbitrary format that includes details required for generating one record.

The acquisition part 330 communicates with the package carrier 200 through the communication part 310. In accordance with this, the acquisition part 330 acquires (receives) a detection result, which is acquired by the weight detection part 240, relating to a package P loaded into the package carriers 200 by a user U from the package carriers 200. For example, the acquisition part 330 may acquire the weight of a package P detected by the weight detection part 240 from the package carrier 200 as a detection result acquired by the weight detection part 240 relating to the package P. Instead of this, the acquisition part 330 may acquire a change in the entire weight of the package carrier 200 between before and after loading of a package P into the package carriers 200 from the package carrier 200 as a detection result, which is acquired by the weight detection part 240, relating to the package P. In such a case, the acquisition part 330 may calculate the weight of the package P on the basis of the change in the entire weight of the package carrier 200 between before and after loading of the package P into the package carriers 200.

For example, the operations decision part 340 includes a transport condition judgement part 341, a selection part 342, a motion decision part 343, and a storage position determination part 344.

The transport condition judgement part 341 judges whether or not a predetermined condition relating to an item or a weight (hereinafter, referred to as “a heavy weight object condition”) is satisfied on the basis of an item of contents of the package P included in the application information received by the reception part 320 before the package carrier 200 directed for collection of the package P is selected. The heavy weight object condition is a condition that is used for judging whether or not there is a possibility of the package P being a heavy package. The heavy weight object condition is one example of “a second predetermined condition”. For example, in a case in which the item of the package P included in the application information corresponds to a specific item (for example, “book” or “beverage”) set in advance, the transport condition judgement part 341 judges that the package P satisfies the heavy weight object condition. Instead of this, the transport condition judgement part 341 may calculate a predicted weight of a package P on the basis of items and quantities of contents of the package P included in the application information and judge that the package P satisfies the heavy weight object condition in a case in which the calculated predicted weight of the package P is equal to or larger than a threshold. A judgement result acquired by the transport condition judgement part 341 is output to the selection part 342.

When a record of new application information is added to the application information list 394, the selection part 342 selects the package carrier 200 provided for the user relating to the application information from among the plurality of package carriers 200 by referring to a list (not shown in the drawing) of the package carriers 200 and the transfer schedule information 396. For example, when it is appropriate to incorporate pickup of the package P into an existing movement schedule of the package carrier 200 that has already been incorporated into the transfer schedule information 396, the selection part 342 adds pickup of the package P to the existing movement schedule. Otherwise, the selection part 342 sets the movement schedule of a new package carrier 200 and registers pickup of the package P.

In this embodiment, in a case in which it is judged by the transport condition judgement part 341 that the package P satisfies the heavy weight object condition, the selection part 342 selects a package carrier 200 of which a vacancy status of the package storage space C of the package carrier 200 satisfies a predetermined condition (hereinafter, referred to as a “vacancy status condition”) as the package carrier 200 directed for collection of the package P. The vacancy status condition is a condition representing that a degree of available loading of the package carrier 200 for a package P that is a collection target is equal to or higher than a predetermined value. The vacancy status condition is one example of “third predetermined condition”. For example, in a case in which it is judged that the package P satisfies the heavy weight object condition, the selection part 342 selects a package carrier 200 in which the number of vacant package storage spaces C is equal to or larger than a predetermined number or of which the weight to be loaded into the current movement schedule is equal to or smaller than a threshold as the package carrier 200 satisfying the vacancy status condition. In accordance with this, even in a case in which a package P is a heavy weight object, the package P can be collected without any problem.

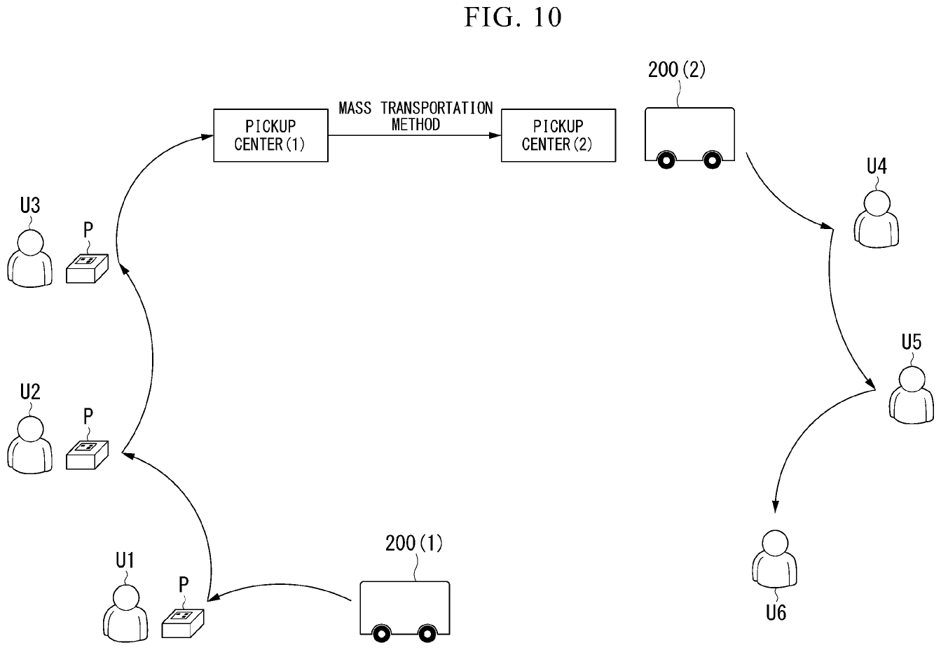

FIG. 10 is a diagram conceptually showing details of the transfer schedule information 396. As shown in the drawing, the transfer schedule information 396 includes information that defines a series of operations as below. A certain package carrier 200(1) picks up a package P of a user U1 at a delivery source place and at a package collection desired time of the user U1. Next, the package carrier 200(1) picks up a package P of a user U2 at a delivery source place and at a package collection desired time of the user U2. Next, information defining a series of operations of picking up a package P of a user U3 at a delivery source place and at a package collection desired time of the user U3 and transporting the packages to a pickup center (1) is included. In the pickup center, after the collected packages P are classified for each region of transport destinations, operations are performed such that the collected packages are transported to other pickup centers. For example, packages P are transported using a large-scale transportation means such as a large track, a railroad, or the like between pickup centers (from the pickup center (1) to the pickup center (2) in the drawing). The transfer schedule information 396 may further include information that defines operations of delivering packages P from the pickup center (2) in order of users U4, U5, and U6. Relating to delivery from a pickup center to a destination, for example, information of a delivery destination position is acquired by searching the application information list 394 using label information acquired from a label L as the key. The operation of the package carrier 200(2) is determined on the basis of the information. Since the present invention mainly focuses on operations at the time of pickup, a further detailed description of delivery will be omitted.

The motion decision part 343 generates the transfer schedule information 396 as described above. For example, the motion decision part 343 roughly groups records of the application information for each date, for each time frame, and for each region. Next, the motion decision part 343 sets several movement patterns in which a plurality of delivery source places and package collection desired times are sequentially aligned. Thereafter, the motion decision part 343 extracts a movement pattern having a lowest movement cost by referring to the map information 398 and adds the extracted movement pattern to the transfer schedule information 396. Regarding techniques for calculation and evaluation of movement costs, various techniques are known in the field of navigation systems, and thus a description thereof will be omitted.

Then, the motion decision part 343 transmits an operation instruction to the package carrier 200 in accordance with details described in the transfer schedule information 396 using the communication part 310. In other words, the motion decision part 343 determines the operation of the package carrier 200 on the basis of the transfer schedule information 396 that is generated on the basis of application information received by the reception part 320. In order to convey a package P into the package carrier 200, the motion decision part 343 transmits an operation instruction for causing the package carrier 200 to stop on the road to the package carrier 200 using the communication part 310. As a relating instruction method, there are methods of transmitting a stop instruction and a method of transmitting a stop position.

In a case in which the weight of a package P (hereinafter, referred to as a “first package P”) is detected by the weight detection part 240 of the package carrier 200, the storage position determination part 344 selects a package storage space C to receive the first package P from among the plurality of package storage spaces C on the basis of the weight balance between the weight of the first package P based on a detection result acquired by the weight detection part 240 and a weight of one or more (for example, a plurality of) packages P (hereinafter, referred to as a “second package P”) that is stored in the package carrier 200 in advance or later. Then, the storage position determination part 344 adds information representing the selected package storage space C to store the package P in the application information list 394.

For example, in a case in which the weight of the first package P based on the detection result acquired by the weight detection part 240 is equal to or higher than a threshold, the storage position determination part 344 selects a package storage space C to receive the first package P from among the plurality of package storage spaces C such that the first package P and the second package P2 of which the weight, similarly, is equal to or higher than the threshold are divided into a storage space of the front side (for example, upper-stage front part storage spaces CF1, CF2, CF3, and CF4) and a storage space of the rear side (for example, the upper-stage rear part storage spaces CB1, CB2, CB3, and CB4). In addition to this or instead of this, in a case in which the weight of the first package P based on the detection result acquired by the weight detection part 240 is equal to or higher than the threshold, the storage position determination part 344 selects a package storage space C to receive the first package P from among the plurality of package storage spaces C such that the first package P and the second package P2 of which the weight, similarly, is equal to or higher than the threshold are divided into a storage space of the left side (for example, the upper-stage front part storage spaces CF1 and CF2 or the upper-stage rear part storage spaces CB1 and CB2) and a storage space of the right side (for example, the upper-stage front part storage spaces CF3 and CF4 or the upper-stage rear part storage spaces CB3 and CB4).

In addition, in a case in which the weight of the first package P based on the detection result acquired by the weight detection part 240 satisfies a predetermined condition (hereinafter, referred to as a “weight condition”), the storage position determination part 344 selects the upper-stage rear part storage space CB5 as a package storage space C that receives the first package P. The weight condition is a condition that is used for judging whether or not the package P is a heavy package. The weight condition is one example of “a first predetermined condition”.

For example, the financial accounting part 350 includes an estimated fee accounting part 351 and a settlement fee accounting part 352. The estimated fee accounting part 351 calculates an estimate of the delivery fee of a package P on the basis of an item and a quantity of contents of the package P included in the application information received by the reception part 320.

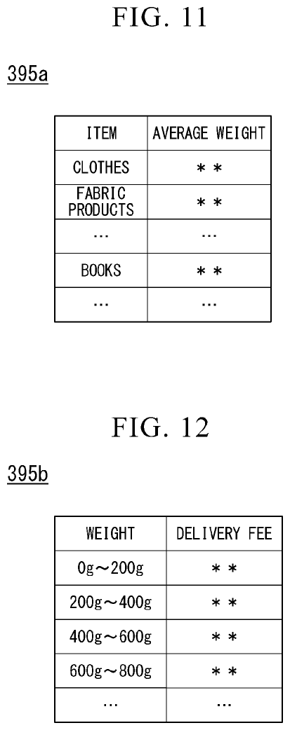

FIG. 11 is a diagram showing an example of details of average weight information 395a that is included in the fee information 395 stored in the memory 390. In the average weight information 395a, an item of contents of a package P and the average weight of each of the contents in registered in association with each other.

FIG. 12 is a diagram showing an example of details of weight fee information 395b that is included in the fee information 395 stored in the memory 390. In the weight fee information 395b, the weight of a package P and a delivery fee of the package P are registered in association with each other. A plurality of delivery fees may be set in accordance with a distance (delivery distance) between a delivery source position and a delivery destination position.

The estimated fee accounting part 351, first, calculates a predicted weight of a package P on the basis of items and quantities of contents of the package P that are included in the application information by referring to the average weight information 395a. More specifically, a predicted weight of a package P is calculated by multiplying the average weight by a quantity for each item of contents of the package included in the average weight information 395a. Then, the estimated fee accounting part 351 calculates an estimate of the delivery fee of the package P on the basis of the calculated predicted weight of the package P and a delivery distance acquired from the application information by referring to the weight fee information 395b.

The settlement fee accounting part 352 calculates a settlement fee of a delivery fee of a package P on the basis of a detection result acquired by the weight detection part 240 relating to the package P acquired by the acquisition part 330. In other words, the settlement fee accounting part 352 calculates a settlement fee of a delivery fee of a package P on the basis of the weight of the package P that is actually measured and a delivery distance that is acquired from the application information. Then, the settlement fee accounting part 352 settles the delivery fee of the package P using the calculated settlement fee of the delivery fee of the package P.

The guide part 360 communicates with the terminal device 100 (or the package carrier 200) through the communication part 310. The guide part 360 guides a user U for various kinds of information by causing the display unit of the terminal device 100 (or a display unit of the package carrier 200 (for example, the second display device 232)) to output various kinds of information. For example, the guide part 360 includes a location information guide part 361, an estimated fee guide part 362, a settlement fee guide part 363, and a storage position guide part 364.

The location information guide part 361 causes the terminal device 100 of the user U to provide location information of the package carrier 200. The location information guide part 361 transmits location information uploaded by the communication control part 271 of the package carrier 200 using the communication device 214 to the terminal device 100 using the communication part 310. For example, the location information guide part 361 transmits information used for displaying an image representing location information by superimposing the image on a map image to the terminal device 100.

Before the package P is loaded into the package carrier 200, the estimated fee guide part 362 guides the user U to an estimate of a delivery fee of the package P calculated by the estimated fee accounting part 351. For example, before an application from the user U is formally determined (for example, in a stage in which application information is input by the user U), the estimated fee guide part 362 transmits information for guiding an estimate of a delivery fee of the package P calculated by the estimated fee accounting part 351 to the terminal device 100 to be caused to be output. In accordance with this, the estimate of the delivery fee is displayed on the transport service application screen of the terminal device 100, and the user U is guided to the estimate of the delivery fee.

The settlement fee guide part 363 guides the user U to the delivery fee of the package P settled by the settlement fee accounting part 352. For example, after a package P is loaded into the package carrier 200 by a user U, and a weight of the package P is detected by the weight detection part 240 of the package carrier 200, the settlement fee guide part 363 transmits information used for guiding the delivery fee (the settled fee) of the package P that is calculated and settled by the settlement fee accounting part 352 to the terminal device 100 to be caused to be output. In accordance with this, the settled fee of the delivery fee is displayed on the transport service application screen of the terminal device 100, and the user U is guided to the settled delivery fee. Instead of this or in addition to this, the settlement fee guide part 363 may guide the user U to the delivery fee that has been calculated by the settlement fee accounting part 352 and has been settled by transmitting the information used for guiding the delivery fee of the package P that has been settled (settled fee) to the second display device 232 of the package carrier 200 to be caused to be output.

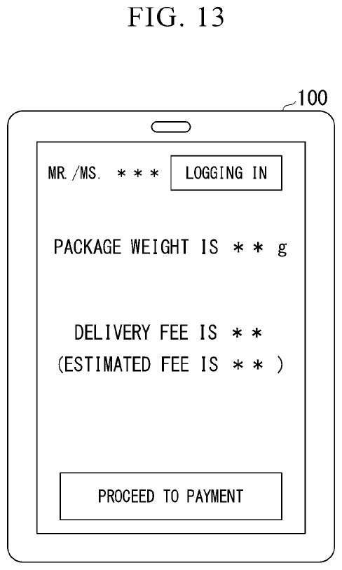

FIG. 13 is a diagram showing an example of the transport service application screen displayed in the display unit of the terminal device 100. As shown in FIG. 13, on the transport service application screen, a delivery fee that has been settled (settled fee) is displayed, and the user U is guided thereto. In addition, on the same screen as the screen on which the settled delivery fee is displayed, the weight of the package P based on a detection result acquired by the weight detection part 240 of the package carrier 200 and/or an estimate of the delivery fee of the package P that has been calculated in advance and is guided for the user U (the amount of estimate) may be displayed.

The storage position guide part 364 transmits information representing the package storage space C, which stores the package P selected by the storage position determination part 344, to the terminal device 100 to be caused to be output, for example, by referring to the application information list 394. In accordance with this, the package storage space C to store the package P of the user U is displayed on the transport service application screen of the terminal device 100, and the user U is guided to the package storage space C to store the package P of the user U. Instead of this or in addition to this, the user U may be guided to the package storage space C to store the package P of the user U by the storage position guide part 364 transmitting information representing the package storage space C storing the package P selected by the storage position determination part 344 to the second display device 232 of the package carrier 200 to be caused to be output.

For example, the authentication processing part 370 acquires various kinds of information (a password, biometric information, a token, and the like) acquired by the authentication device 253 of the package carrier 200 and, in a case in which the acquired information is valid, notifies the motion decision part 343 of information indicating that authentication has been successful. Upon receiving this, the motion decision part 343 transmits information for an instruction for opening one door 220 to the package carrier 200. In the package carrier 200, the opening and closing mechanism control part 274 drives the opening and closing mechanism 262 to open the designated door 220. After storing the package P in the package storage space C, for example, the user U manually closes the door 220. The package carrier 200 detects that the door 220 has been closed on the basis of information from an attached switch using the door 220 and starts to move toward a next delivery source place.

The accounts processing part 380 performs a process for collecting a fee from the user U. For example, the accounts processing part 380 collects a fee from the user U in cooperation with a management server of a credit card or electronic money. The accounts processing part 380 gives a privilege to a user U by discounting of the fee of this time or assigning a coupon for a future use to the user U who uses a prescribed label.

### [4. Processing Sequence]

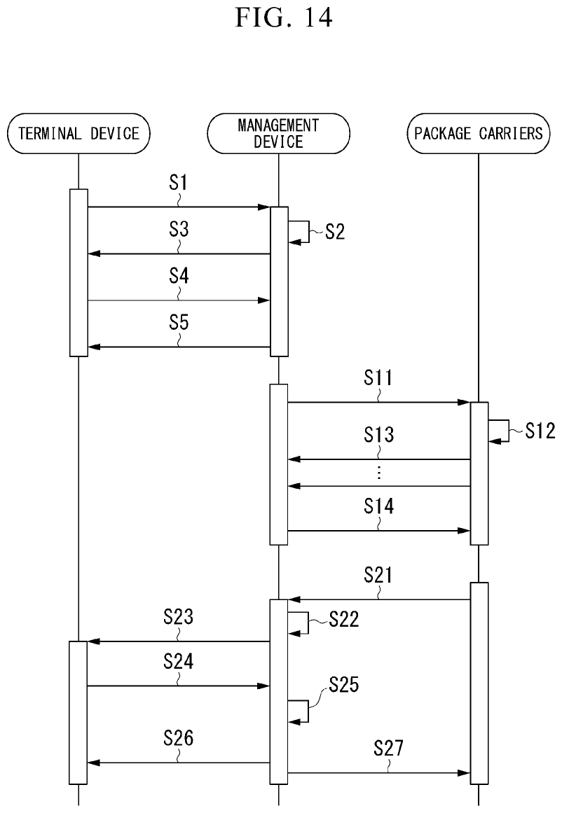

FIG. 14 is a sequence diagram showing an example of the flow of a process for pickup that is executed in the transport system 1. First, the terminal device 100 transmits application information to the management device 300 (Step S1). Next, the estimated fee accounting part 351 of the management device 300 calculates an estimate of a delivery fee of a package P (the amount of estimate) on the basis of items and quantities of contents of the package P and a delivery distance of the package P included in the application information received from the terminal device 100 (Step S2). Next, the estimated fee guide part 362 of the management device 300 guides the user U to an estimate of a delivery fee of the package P by transmitting information used for guiding the calculated estimate of the delivery fee of the package P to the terminal device 100 to be caused to be output (Step S3). Next, in a case in which an input of the user U indicating an agreement to the estimate of the delivery fee of the package P has been received, the terminal device 100 transmits information indicating the agreement of the user U to the estimate to the management device 300 (Step S4). The reception part 320 of the management device 300 completes reception of the delivery of the package P by receiving the information indicating an agreement of the user U to the estimate from the terminal device 100 and transmits a notification of completion of reception to the terminal device 100 (Step S5).

When it becomes a departure timing of the package carrier 200, the motion decision part 343 of the management device 300 transmits a path and a start instruction to the package carrier 200 (Step S11). The package carrier 200 performs autonomous travel along the path (Step S12). The package carrier 200 regularly uploads its location information to the management device 300 (Step S13). When the package carrier 200 arrives at a delivery source position, the management device 300 transmits a stop instruction to the package carrier 200 (Step S14). Here, it is assumed that a stop instruction is performed using a related technique. The package carrier 200 receives a stop instruction and stops on a road.

In a case in which the package carrier 200 stops at the applied delivery source position, in order to measure an accurate weight of the package P that is a delivery target, the user U loads the package P that is the delivery target into the package carrier 200. In this embodiment, the user U measures the weight of the package P using the weight detection part 240 of the package carrier 200 by loading the package P into a weight detection area DT disposed in the upper face 210c of the vehicle body 210 of the package carrier 200. The detection result of the weight of the package P detected by the weight detection part 240 is transmitted from the package carrier 200 to the acquisition part 330 of the management device 300 (Step S21).

Next, the settlement fee accounting part 352 of the management device 300 calculates a settled fee of the delivery fee of the package P on the basis of a detection result, which is acquired by the weight detection part 240, relating to the package P acquired by the acquisition part 330 (in other words, an accurate weight of the package P) and a delivery distance of the package P included in the application information, and the delivery fee of the package P is settled (Step S22). The settlement fee guide part 363 of the management device 300 transmits information for guiding the settled delivery fee of the package P to the terminal device 100 and causes the display unit of the terminal device 100 to display the information (Step S23). In accordance with this, the user U is guided to the settled delivery fee of the package P. In addition, as described above, instead of the description presented above or in addition to the description presented above, information representing the settled delivery fee of the package P may be used for guiding the user U by being transmitted from the settlement fee guide part 363 of the management device 300 to the package carrier 200 and displayed in the second display device 232 of the package carrier 200.

Next, the terminal device 100 receives information required for authentication of the user U and/or payment of the delivery fee of the package P on the basis of an input from the user U and transmits the received information to the management device 300 (Step S24). The process of this Step S24 may be performed after Steps S25, S26, and S27 to be described below.

Next, the storage position determination part 344 of the management device 300 selects and determines a package storage space C to store the package P from among the plurality of package storage spaces C on the basis of the detection result of the weight of the package P acquired in Step S21 (Step S25). Information representing the determined package storage space C is transmitted to the terminal device 100 by the storage position guide part 364 of the management device 300 and is displayed in the display unit of the terminal device 100 (Step S26). In accordance with this, the user U is guided to the package storage space C to store the package P of the user U. In addition, instead of this or in addition to this, the information representing the determined package storage space C may be used for guiding the user U by being transmitted from the storage position guide part 364 of the management device 300 to the package carrier 200 and displayed in the second display device 232 of the package carrier 200.

Next, the management device 300 transmits information representing the package storage space C determined by the storage position determination part 344 to the package carrier 200 (Step S27). The opening and closing mechanism control part 274 of the package carrier 200 controls the opening and closing mechanism 262 on the basis of the information representing the determined package storage space C, thereby opening a door 220 corresponding to the determined package storage space C. The process of Step S27 may be performed before Step S26 or simultaneously with Step S26. Then, when the door 220 is closed by the user U, the package carrier 200 starts to move toward a next delivery source place or a pickup center. In this way, the pickup is completed.

### [5. Operation]

In delivery of a package P, a delivery load greatly differs depending on the weight of the package P, and thus there are cases in which a meter-rate fee according to the weight of the package P may be set. In such cases, in a case in which a user U is requested to report an accurate weight of a package P, there is a likelihood of the convenience of the user U regarding payment of a fee being reduced.

Thus, this embodiment includes the acquisition part 330 that acquires a detection result acquired by the weight detection part 240 from the package carrier 200 in a case in which a package P is loaded into the package carrier 200 by a user and the financial accounting part 350 that settles a delivery fee of the package P on the basis of the detection result acquired by the weight detection part 240 that is acquired by the acquisition part 330. According to such a configuration, a delivery fee can be settled in accordance with the weight of a package P without a user U reporting an accurate weight of the package P. For this reason, the convenience of the user U can be improved.

In this embodiment, before a package P is loaded into the package carrier 200 (for example, in a stage of a delivery application), a user U is guided to an estimate of the delivery fee of the package P. In accordance with this, the user U can notice the reference of the delivery fee, and a judgement of applying delivery of a package P or refraining from the application can be easily performed. In this way, the convenience of the user U can be further improved.

In this embodiment, a user U is guided to an estimate of a delivery fee calculated on the basis of items and quantities of contents of the package P that are included in the application information input by the user U. In accordance with this, for example, even in a case in which heavy contents are included in the package P such as “book” and “beverage”, the user U can be guided to an estimate of the delivery fee that is calculated with relatively high accuracy. In this way, the convenience of the user U can be further improved.

In this embodiment, a package storage space C to receive the first package P is selected from among a plurality of package storage spaces C on the basis of a weight balance between the weight of the first package P based on a detection result acquired by the weight detection part 240 of the package carriers 200 and the weight of the second package P that is stored in the package carriers 200 first or later, and the user U is guided thereto. According to such a configuration, the traveling stability of the package carrier 200 at the time of loading a package P is improved, and safety and energy saving relating to movement of the package carrier 200 can be improved. In accordance with this, the convenience of the user U can be further improved.

In this embodiment, in a case in which the weight of the first package P based on a detection result acquired by the weight detection part 240 of the package carrier 200 satisfies the weight condition described above, the user U is guided to a lower-stage rear part storage space CB52 as the package storage space C to receive the first package P. According to such a configuration, a package P that is a heavy weight object is stored at a relatively low position in the package carrier 200, and the center of gravity of the package carrier 200 can be easily lowered. In this way, the traveling stability of the package carrier 200 is improved, and safety and energy saving relating to movement of the package carrier 200 can be improved. In accordance with this, the convenience of the user U can be further improved.

### Second Embodiment

Next, a second embodiment will be described. In the second embodiment, a report of the weight of a package P is received from a user U, which is different from the first embodiment. The other configurations described below are similar to those of the first embodiment.

In this embodiment, a reception part 320 of a management device 300 receives a report of the weight of a package P from a user U. For example, a report of the weight of a package is performed on the basis of a measurement result acquired by a user U performing measurement using a scale or a weight estimated by the user U.

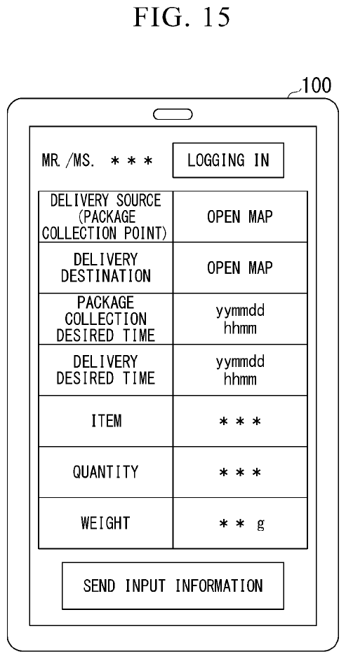

FIG. 15 is a diagram showing an example of a transport service application screen for inputting application information that is displayed in a display unit of a terminal device 100. In this embodiment, as a first item of the application information, an input of a report of the weight of a package P is received. In a case in which a report of the weight of a package P is input as the first item of the application information, an estimated fee accounting part 351 of the management device 300 calculates an estimate of a delivery fee of the package P based on the report of the weight of the package P. Then, an estimated fee guide part 362 of the management device 300 guides the user U to the estimate of the delivery fee of the package P that has been calculated by the estimated fee accounting part 351.

According to such a configuration, the accuracy of the estimate of the delivery fee of the package P can be further raised. In accordance with this, the convenience of the user U can be newly improved.

### Third Embodiment

Next, a third embodiment will be described. In this third embodiment, a user is guided to limited items of packages P that can be delivered by a package carrier 200, which is different from the first embodiment. The configurations other than those described below are similar to those of the first embodiment.

In this embodiment, a management device 300 can provide a service for early collecting a package P by aggressively using a package carrier 200 that has already been incorporated into a transfer schedule information 396 (hereinafter, referred to as “a specific package carrier 200”). In this case, when an application for collection of a package P using the specific package carrier 200 is received, a guide part 360 of the management device 300 calculates a total weight of packages P that are planned to be stored in the specific package carrier 200 on the basis of application information list 394 and the transfer schedule information 396 and, in a case in which the calculated total weight is equal to or larger than a threshold, displays a list of limited items as a list of items of packages P that can be delivered by the package carrier 200 on a transport service application screen. For example, the limited items are items of relatively light packages and/or items of relatively small packages.

According to such a configuration, by more effectively utilizing the specific package carrier 200, a service for early collecting a package P can be provided for a user U. In accordance with this, the convenience of the user U can be further improved.

The embodiments described above can be expressed as below.

A management device that manages a service using an unmanned delivery unit having a weight detection part, the management device including a storage device storing a program and a hardware processor and, by the hardware processor executing the program, is configured to acquire a detection result, which is acquired by the weight detection part, relating to a first package loaded into the unmanned delivery unit by a user from the unmanned delivery unit, settle a delivery fee of the first package on the basis of the acquired detection result, which is acquired by the weight detection part, relating to the first package, and cause a terminal device to output information for guiding the settled delivery fee of the first package.

While preferred embodiments of the invention have been described and shown above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

### EXPLANATION OF REFERENCES

100 Terminal device
200 Package carrier
210 Vehicle body
220 Door
240 Weight detection part
300 Management device
320 Reception part
330 Acquisition part
340 Operations decision part
341 Transport condition judgement part
342 Selection part
350 Financial accounting part
360 Guide part
C Package storage space
U User
P Package

What is claimed is:

1. A management device that is configured to manage a service using an unmanned delivery unit having a weight detection part, the management device comprising:
an acquisition part configured to acquire a detection result, which is acquired by the weight detection part, relating to a first package loaded into the unmanned delivery unit by a user from the unmanned delivery unit;
a financial accounting part configured to settle a delivery fee of the first package on the basis of the detection result, which is acquired by the weight detection part, relating to the first package that is acquired by the acquisition part; and
a guide part configured to cause a terminal device to output information for guiding the delivery fee of the first package that is settled by the financial accounting part.

2. The management device according to claim 1, wherein the guide part is configured to cause the terminal device to output information for guiding an estimate of the delivery fee of the first package before the first package is loaded into the unmanned delivery unit.

3. The management device according to claim 2, further comprising a reception part configured to receive a delivery request including items and quantities of contents of the first package from the terminal device,
wherein the guide part is configured to cause the terminal device to output information for guiding an estimate of the delivery fee of the first package on the basis of the items and the quantities of the contents of the first package included in the delivery request received by the reception part.

4. The management device according to claim 2, further comprising a reception part configured to receive a report of a weight of the first package from the terminal device,
wherein the guide part is configured to cause the terminal device to output information for guiding an estimate of the delivery fee of the first package on the basis of the report of the weight of the first package received by the reception part.

5. The management device according to claim 1,
wherein the unmanned delivery unit includes a plurality of package storage spaces, and
wherein the guide part is configured to cause the terminal device to output information representing a package storage space to receive the first package selected from among the plurality of package storage spaces on the basis of a weight balance between a weight of the first package on the basis of the detection result acquired by the weight detection part and a weight of a second package stored in the unmanned delivery unit in advance or later.

6. The management device according to claim 1,
wherein the unmanned delivery unit includes a first package storage space and a second package storage space disposed below the first package storage space, and
wherein the guide part is configured to cause the terminal device to output information representing the second package storage space as a package storage space to receive the first package in a case in which a weight of the first package on the basis of the detection result acquired by the weight detection part satisfies a first predetermined condition.

7. The management device according to claim 1, further comprising:
a reception part configured to receive a delivery request including items of contents of the first package from the terminal device; and
a transport condition judgement part configured to judge whether or not the first package satisfies a second predetermined condition relating to an item or a weight on the basis of the items of the contents of the first package included in the delivery request received by the reception part before the unmanned delivery unit suited for collection of the first package is selected.

8. The management device according to claim 7, further comprising a selection part configured to select the unmanned delivery unit of which a vacancy status of the package storage space satisfies a third predetermined condition as the unmanned delivery unit suited for collection of the first package in a case in which it is judged by the transport condition judgement part that the first package satisfies the second predetermined condition.

9. The management device according to claim 1, wherein the guide part is configured to cause the terminal device to output information for guiding items of contents of packages that can be delivered by the unmanned delivery unit.

10. A transport system comprising:
the management device according to claim 1; and
an unmanned delivery unit,
wherein the unmanned delivery unit has a measurement area in an upper face of a vehicle body of the unmanned delivery unit, and
wherein the weight detection part is configured to detect a weight of a package loaded into the measurement area.

11. A transport system comprising:
the management device according to claim 1; and
an unmanned delivery unit,
wherein the weight detection part is configured to detect a weight of a package loaded into the unmanned delivery unit on the basis of a change in an entire weight of the unmanned delivery unit.

12. A management method using a management device that is configured to manage a service using an unmanned delivery unit including a weight detection part, the management method comprising:
acquiring a detection result, which is acquired by the weight detection part, relating to a first package loaded into the unmanned delivery unit by a user from the unmanned delivery unit;
settling a delivery fee of the first package on the basis of the acquired detection result, which is acquired by the weight detection part, relating to the first package; and
outputting information for guiding the settled delivery fee of the first package to a terminal device.

13. A program causing a computer of a management device that is configured to manage a service using an unmanned delivery unit including a weight detection part to perform:
acquiring a detection result, which is acquired by the weight detection part, relating to a first package loaded into the unmanned delivery unit by a user from the unmanned delivery unit;
settling a delivery fee of the first package on the basis of the acquired detection result, which is acquired by the weight detection part, relating to the first package; and
causing a terminal device to output information for guiding the settled delivery fee of the first package.
